(19) United States
(12) Patent Application Publication
(10) Pub. No.: US 2004/0198230 A1
(43) Pub. Date: Oct. 7, 2004

(54) Compact digital camera, Internet radio and/or AM/FM radio incorporated into the specially designed cell phone for neck bag users

(76) Inventor: Christophe Obolo, Stamford, CT (US)

Correspondence Address: CHRISTOPHE OBOLO, 138 WOODSIDE GREEN, UNIT 4, STAMFORD, CT, 06905, US

(21) Appl. No.: 10/228,851

(22) Filed: Aug. 27, 2002

(51) Int. Cl. H04B 7/00; H04M 1/00; H04B 1/38

(52) U.S. Cl. 455/66.1; 455/404.1; 455/456.1; 455/569.1

(57) ABSTRACT

This invention is basically an improvement, with incorporation of new products, of neck bag and accessories; invented by Christophe Obolo, application Ser. No. 10/152114, and including digital video and photo cameras, which will allow people to catch any moments in their lives, along with Internet, and or AM/FM radio. The digital camera is basically a third eye for people. The chin-clipped microphone along with an earphone clipped on one's ear, are an alternative to the built-in flexible microphone speakerphone but also a version that is very practical for some sporting activities such as running, whereby a phone mounted on one's arm or chest/trunk is encased in a watertight pouch to avoid sweat contact with phone, for instance when running or brisk walking. The talking body is basically an extension of speakerphone that is flexible and extendable up to your ear side and may be an alternative for those who don't like earphones. The mouth piece or breathing chamber, equipped with a corded or cordless powerful microphone will be useful for communication in deep diving activities, biological and/or chemical warfare, cave exploration, fire rescues, dangerous deep mining activities, and airborne operations. An elevation of built-in speakerphone/microphone and or neck bag may improve sound transmission as well. Lastly, the neck bag can be modified to fit walk-men and/or digital music device such as MP

### BACKGROUND OF INVENTION

This invention pertains to an improvement of neck bag and accessories invention, and represents an integrated and improved electronic system incorporated into a cell phone fitted into the neck bag for cell phone users.

### SUMMARY OF INVENTION

The compact digital video and/or photo camera is essentially a “third eye” that people can use as they need, and the incorporated internet and or AM/FM radio will allow users to catch and enjoy any moments in their lives.

The talking body device is essentially a powerful microphone/transmitter mounted on one side of the phone and an extension of the speakerphone/microphone, and represents a device that is flexible and capable of being extended up to user's ear, mouth or mandible for better communication.

An elevation of a built-in speakerphone/microphone and/or neck bag for cell phone users can accomplish an improvement in sound transmission also for the same purpose.

### BRIEF DESCRIPTION OF THE DRAWINGS

FIG. 1: drawing page 1

FIG. 1A: Talking body device fitted into the side of cell phone. It's flexible and extendable

FIG. 1B: Talking body is extended as illustrated

FIG. 2: drawing page 2

Cordless clippable earphone clipped onto earlobe

FIG. 3: drawing page 3

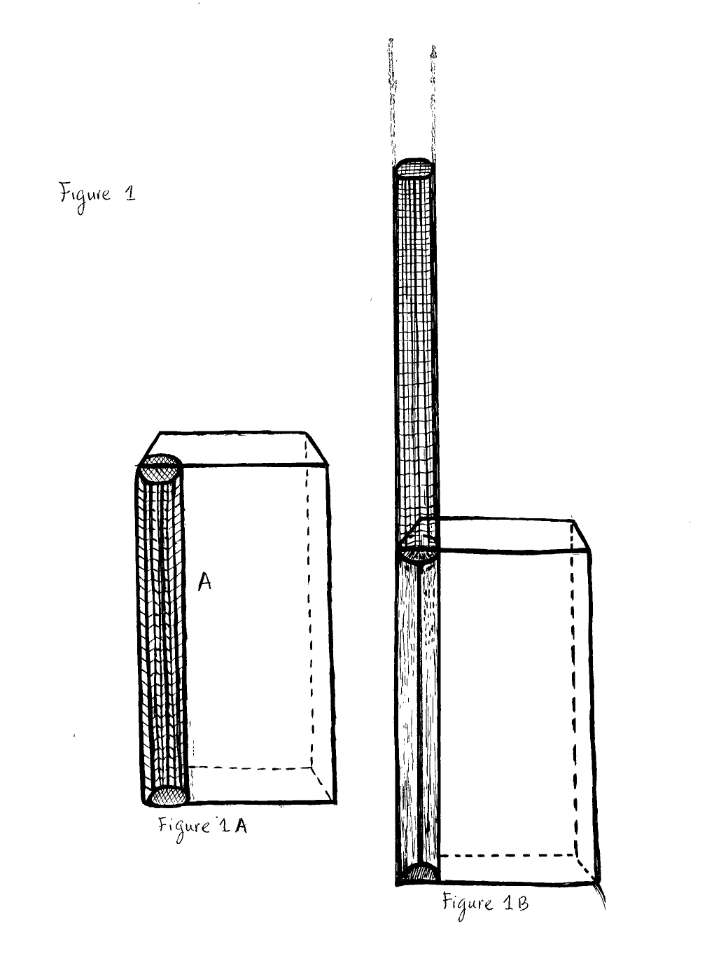

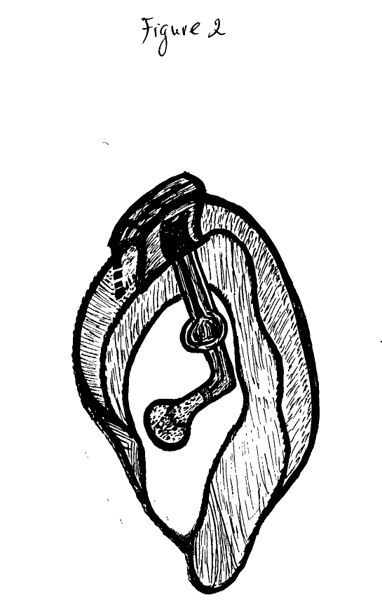

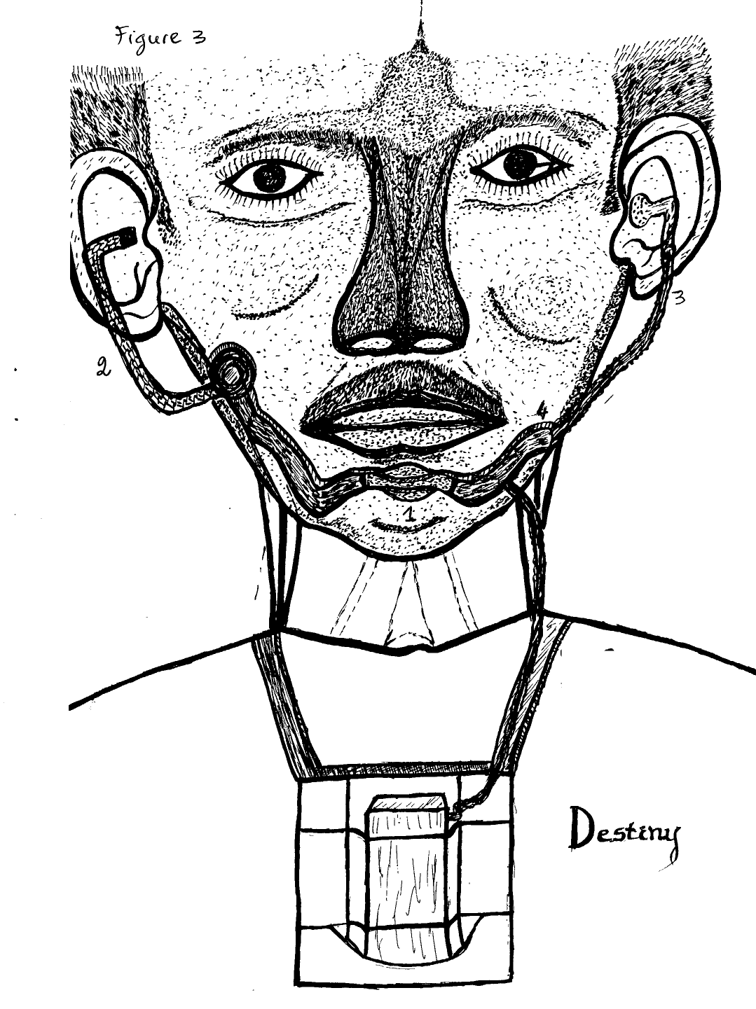

Chin-clipped microphone FIG. 4.1

Talking body FIG. 4.2

Earphone FIG. 4.3

Chinclip FIG. 4.4

### DETAILED DESCRIPTION OF THE INVENTION

This invention is simply an improvement to the neck bag and accessories invented by Christophe Obolo; application Ser. No. 10/152114. This new invention relates to talking body device, which is a flexible rod and an extension of the speakerphone/microphone, which can be extended superiorly toward ear or mouth. Alternatively, the built-in elevation of speakerphone/microphone and/or neck bag to improve sound transmission. This flexible rod will have a powerful microphone/transmitter mounted along its length, allowing better sound transmission.

The compact digital video and photo camera is basically a third eye that will allow people to catch any moments in their lives along with an Internet and/or AM/FM radio.

A midline strap strap mounted on neck bag base may be worn around trunk and or arm; this model may have a watertight pouch into which is fitted a powerful cell phone and/or radio transmitter/receiver, equipped with an ear phone poweful microphone mounted on chinclip or a corded or cordless mcrophone mounted into a mouth piece and/or breathing chamber

This model will permit people to communicated during deep diving,air borne, firefighting, cave exploration, warfare, and dangerous mining and

A midline strap strap mounted on neck bag base may be worn around trunk and or arm; this model may have a watertight pouch into which is fitted a powerful cell phone and/or radio transmitter/receiver, equipped with an ear phone poweful microphone mounted on chinclip or a corded or cordless mcrophone mounted into a mouth piece and/or breathing chamber

This model will permit people to communicated during deep diving,air borne, firefighting, cave exploration, warfare, and dangerous mining and cleaning and sporting activities. Alternatively, surgeons may use this particular model to communicate in rescue operations and/or warfare.

The cordless earpiece or phone is also an extension of the speakerphone/microphone, which allows people to communicate better. This cordless earpiece,equipped, with a clip for wearing on earlobe.

What I claim as my invention is:

1. Talking body

2. Microphone/speakerphone elevation

3. Mouthpiece or breathing chamber with microphone

4. Chin mountable microphone with extendable earphone or talking body

5. Radiation shielding pad for neck bag

6. Midline strap for neck bag

7. Compact digital camera, Internet radio and/or AM/FM encased in the cell phone for neck bag users

8. Watertight pouch for neck bag base with midline straps for wearing on trunk or arm

9. Neck bag and assessories may be modified to carry walk-man, and digital music devices of type MP
